(19) United States
(12) Patent Application Publication
(10) Pub. No.: US 2026/0007577 A1
(43) Pub. Date: Jan. 8, 2026

(54) IMPROVEMENTS IN AND RELATING TO PILL DISPENSER MECHANISMS, PILL DISPENSER ASSEMBLIES AND METHODS

(71) Applicant: PILL CONNECT LIMITED, Greater Manchester (GB)

(72) Inventors: James BURNSTONE, Greater Manchester (GB); Robert SMITH, Greater Manchester (GB)

(21) Appl. No.: 18/881,709

(22) PCT Filed: Jul. 7, 2023
(86) PCT No.: PCT/GB2023/051793

§ 371 Date: Jan. 6, 2025

(30) Foreign Application Priority Data
Jul. 8, 2022 (GB) 2210060.6

(51) Int. Cl. A61J 7/00

(52) U.S. Cl. CPC A61J 7/0076

(57) ABSTRACT

A pill dispenser mechanism for a pill dispenser assembly includes: a chamber; a product sensor configured to sense the presence or absence of the pill in the chamber; a drive mechanism operable to cause movement of the chamber; and a control unit configured to control the drive mechanism based on the output of the product sensor. Also provided is a pill dispenser assembly comprising the pill dispenser mechanism, wherein the control unit is configured to control the drive mechanism to cause movement of the chamber between: a first loading position wherein the chamber is in communication with a product entry passage but out of communication with a product exit passage; and a second dispensing position wherein the chamber is out of communication with the product entry passage but in communication with the product exit passage.

### FIELD

The present disclosure relates to a pill dispenser mechanism, a pill dispenser assembly, a kit of parts, a method of operation of a pill dispenser mechanism, and to a method of operation of a pill dispenser assembly.

### BACKGROUND TO THE INVENTION

Products, such as pharmaceuticals and dietary supplements, are administered to patients (i.e., an intended recipient of the product). In a number of instances, it is necessary for the patient to administer themselves the correct dose of product.

Conventionally, a pill (a “unit of product”), such as a pharmaceutical drug or dietary supplement, may be provided in a packaging such as a container. For example, a pill may be a pharmaceutical drug provided in pill form in a standard medicine bottle. A person may be required to take a specific number of pills per unit time.

Devices have been developed to assist a patient in taking a dose by dispensing pills. There are a number of problems with existing devices.

One problem is that the device may not successfully dispense a pill. This might cause a patient to struggle to access a dose, or cause a patient to miss a dose. Another problem is that the device may allow the patient to (deliberately or inadvertently) dispense a dose that is greater than required or is safe.

One scenario in which it is particularly important to ensure that a patient is administering the correct dose is in clinical trial. In clinical trial, a patient may be monitored for adherence. Adherence is the rate at which a patient follows a prescribed regimen for administering a product such as a drug. Adherence needs to be high for the drug to be able to have its desired effect. Unfortunately, adherence by patients is highly variable. It is estimated that 50-70% of drugs are not taken correctly. This is having knock on effects on the outcome of treatments, clinical trials, and increasing costs in the healthcare sector.

Smart packaging is a technology where electronic circuitry, monitoring or control functions are incorporated in medicine packaging to support adherence. Smart packaging can record a dispensing event, which as an example may include a pill being dispensed from a container.

The dispensing event is recorded as an “adherence action”, e.g., the patient has administered or interacted with their dose. For this data to be useful to a monitoring system, or to inform a clinical trial, there must be high confidence that the recorded dispensing event is representative of an actual adherence action.

However, a problem with existing smart packaging is that it is possible for them to incorrectly report an adherence event. A patient may tamper with the smart packaging to cause a dispensing event to be recorded. A malfunction in the smart packaging may cause a dispensing event to be recorded where one has not taken place. In a specific example, a patient may replace the pill into the container, thereby invalidating a count of the pills remaining in the container.

More generally, it is desired to improve safety in administration of doses of product to patients. Some patients may forget that they have taken their dose and will therefore attempt to dispense additional pills. Some patients will refuse to take their dose and will therefore attempt to tamper with or fool a device into recording a dispensing event.

It is one aim of the present invention, amongst others, to provide an improved mechanism, assembly and/or method thereof and/or address one or more of the problems discussed above, or discussed elsewhere, or to at least provide an alternative mechanism, assembly and/or method.

### SUMMARY OF THE INVENTION

A first aspect provides a pill dispenser mechanism for a pill dispenser assembly, the pill dispenser mechanism comprising: a chamber configured to receive a pill; a product sensor configured to sense the presence or absence of the pill in the chamber; a drive mechanism operable to cause movement of the chamber; and a control unit configured to control the drive mechanism based on the output of the product sensor.

In one example, the drive mechanism is operable to cause rotational movement of the chamber.

In one example, the pill dispenser mechanism comprises an arresting arrangement arranged to arrest movement of the chamber beyond one or more positions of displacement.

In one example, the pill dispenser mechanism comprises an orientation sensor configured to sense the orientation of the pill dispenser mechanism, wherein the control unit is configured to control the drive mechanism based on the output of the orientation sensor.

In one example, the pill dispenser mechanism comprises a position sensor configured to sense the position of the chamber, wherein the control unit is configured to control the drive mechanism based on the output of the position sensor.

A second aspect provides a pill dispenser assembly comprising: a pill dispenser mechanism according to the first aspect; a first portion having a product entry passage; and a second portion having a product exit passage, wherein the pill dispenser mechanism is located between the first portion and second portion, the pill dispenser mechanism being moveable relative to the first portion and second portion, wherein the control unit is configured to control the drive mechanism to cause movement of the chamber between: a first loading position wherein the chamber is in communication with the product entry passage but out of communication with the product exit passage; and a second dispensing position wherein the chamber is out of communication with the product entry passage but in communication with the product exit passage.

In one example, the control unit is configured to control the drive mechanism to cause movement of the chamber between the first loading position, the second dispensing position, and a third intermediate position wherein the chamber is out of communication with both the product entry passage and the product exit passage.

In one example, the control unit is configured to control the drive mechanism to cause movement of the chamber away from the first loading position based on one or more of: the output of the orientation sensor indicating that the mechanism is in a first orientation; the output of the product sensor indicating the presence of a pill in the chamber; and the output of the position sensor indicating that the chamber is in the first locating position.

In one example, the control unit is configured to control the drive mechanism to cause movement of the chamber from the first loading position to the second dispensing position.

In one example, the control unit is configured to control the drive mechanism to cause movement of the chamber from the first loading position to second dispensing position via the third intermediate position.

In one example, the control unit is configured to control the drive mechanism to cause movement of the chamber away from the second dispensing position based on one or more of: the output of the orientation sensor indicating that the mechanism is in a first orientation; the output of the product sensor indicating the absence of a pill in the chamber; and the output of the position sensor indicating that the chamber is in the second dispensing position.

In one example, the control unit is configured to control the drive mechanism to cause movement of the chamber from the second dispensing position to the first loading position.

In one example, the control unit is configured to control the drive mechanism to cause movement of the chamber from the second dispensing position to the first loading position via the third intermediate position.

In one example, the pill dispenser mechanism comprises one or more blocking members arranged to block the product entry passage when the chamber is not in the first loading position.

In one example, the first portion comprises a plurality of product entry passages and the blocking members are arranged to block at least one of the plurality of product entry passages that the chamber is not in communication with in the first loading position.

In one example, the blocking members and arresting arrangement are at least in part defined by a pair of arms extending from or adjacent to the chamber.

A third aspect provides a pill dispenser mechanism according to the first aspect, or a pill dispenser assembly according to the second aspect, wherein the pill dispenser mechanism or pill dispenser assembly is retro-fitted to the opening of an existing container.

A fourth aspect provides a kit of parts comprising a pill dispenser mechanism according to the first aspect, or a pill dispenser assembly according to the second aspect, and a container for containing one or more pills.

A fifth aspect provides a method of operation of a pill dispenser mechanism comprising: sensing the presence or absence of a pill in a chamber; and controlling a drive mechanism operable to cause movement of the chamber based on the sensing the presence or absence of the pill in the chamber.

In one example, the method comprises: sensing the orientation of the pill dispenser mechanism; and controlling the drive mechanism based on the sensing the orientation of the pill dispenser mechanism.

A sixth aspect provides a method of operation of a pill dispenser assembly comprising: controlling a drive mechanism to cause movement of a chamber between: a first loading position wherein the chamber is in communication with a product entry passage but out of communication with a product exit passage; and a second dispensing position wherein the chamber is out of communication with the product entry passage but in communication with the product exit passage.

It will of course be appreciated that features described in relation to one aspect of the present invention may be incorporated into other aspects of the present invention. For example, the method of any aspect of the invention may incorporate any of the features described with reference to the mechanism, assembly and/or kit of any aspect of the invention and vice versa.

Other preferred and advantageous features of the invention will be apparent from the following description.

### BRIEF DESCRIPTION OF THE FIGURES

For a better understanding of the invention, and to show how embodiments of the same may be carried into effect, reference will now be made, by way of example only, to the accompanying diagrammatic drawings in which:

FIG. 1 shows a perspective view of pill dispenser assembly attached to a container;

FIG. 2 shows an exploded view of a pill dispenser assembly;

FIG. 3 shows a lower perspective view of the pill dispenser assembly of FIG. 2;

FIG. 4 shows an upper perspective view of the pill dispenser assembly of FIG. 2;

FIG. 5 shows a sorter member;

FIG. 6 shows a chassis;

FIG. 7 shows a main body;

FIG. 8 shows a pill dispenser mechanism;

FIG. 8a shows a component of the pill dispenser mechanism;

FIG. 9 shows a flowchart of operation of the pill dispenser mechanism and assembly;

FIG. 10 shows snapshots of the chamber of the pill dispenser mechanism;

FIG. 11 shows a schematic kit of parts;

FIG. 12 shows general methodology principles; and

FIG. 13 shows general methodology principles.

### DETAILED DESCRIPTION OF THE INVENTION

According to the present invention there is provided a mechanism, assembly, kit and method as set forth in the appended claims. Other features of the invention will be apparent from the dependent claims, and the description which follows.

The description which follows describes a number of embodiments. The embodiments are only embodiments of the invention where the system and method is as defined in the claims that follow. The reader will appreciate that features of the embodiments which do not fall within the scope of the invention may nevertheless be incorporated in embodiments of the invention which do fall within the scope of the invention. For this reason, the description of the embodiments which are absent these features are retained in order to provide useful background information to the reader.

A pill dispenser assembly 10 and pill dispenser mechanism 100 are described herein. It will be appreciated that benefits of the invention may be derived by providing the pill dispenser mechanism 100 in isolation. For example, the pill dispenser mechanism 100 may be suitable for retrofit in an existing assembly, thereby to provide an improved pill dispenser assembly. Nevertheless, the pill dispenser mechanism 100 is particularly advantageous when provided as part of a pill dispenser assembly 10, or as a kit comprising the pill dispenser mechanism 100, as herein described.

Furthermore, the pill dispenser mechanism 100 or pill dispenser assembly 10 are described as being retro-fitted to the opening of an existing container. That is, a container (e.g., a pill bottle) may be provided, and a pill dispenser mechanism 100 or pill dispenser assembly 10 may be retro-fitted to the container to dispense pills therefrom. This is particularly advantageous as the assembly 10 or mechanism 100 can be provided to dispense pills from generic containers, for example during clinical trial or for particular patients. Nevertheless, in other examples, it is possible to manufacture containers comprising components of the pill dispenser assembly 10 or pill dispenser mechanism 100.

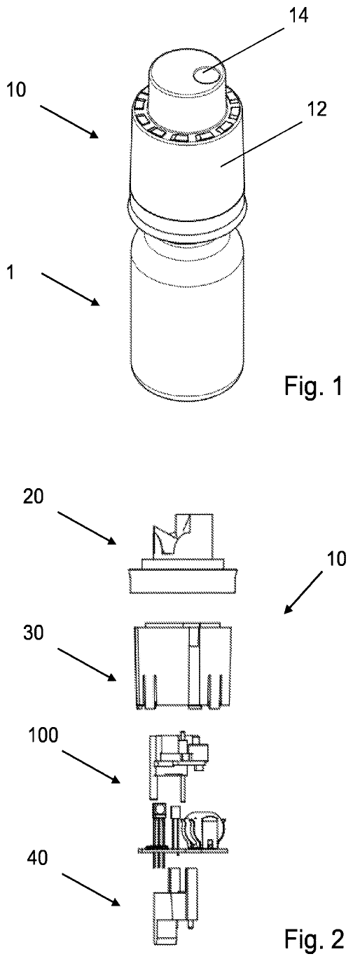

Referring to FIG. 1, the pill dispenser assembly 10 is shown attached to a container 1 for containing one or more pills. The pill dispenser assembly 10 engages with the opening of the container 1 by corresponding screw threads provided at the container 1 and at the pill dispenser assembly 10. The pill dispenser assembly 10 comprises a housing assembly 12. The housing assembly 12 comprises an opening 14 through which a pill is dispensed to the user (e.g., a patient or intended recipient of the dose). A cap (not shown) may further be provided over the upper portion of the housing assembly 12, to cover the opening 14. The cap may be connected to the housing assembly 12 by a screw thread provided on the cap engaging a corresponding screw thread provided at the upper region of the housing assembly 12.

In use, during a dispensing process, the container 1 and pill dispenser assembly 10 engaged therewith are inverted (relative to the orientation shown in FIG. 1, with vertical axis indicated at 2) such that the container 1 is disposed vertically above the pill dispenser assembly 10.

During the dispensing process, a pill travels from the container 1, down into and through the pill dispenser assembly 10, and is dispensed to the user via the opening 14. The dispensing process is thus gravity-assisted.

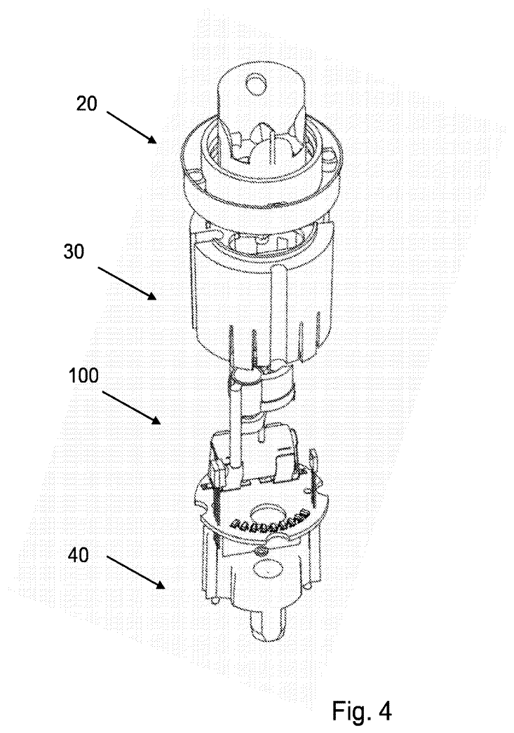

Referring to FIGS. 2, 3 and 4, the pill dispenser assembly 10 is shown in exploded side view, exploded lower perspective view, and exploded upper perspective view, respectively, with the housing assembly 12 absent. In each of FIGS. 2, 3 and 4, the pill dispenser assembly 10 is in the inverted orientation, which is the orientation required for the dispensing process. The pill dispenser assembly 10 comprises a sorter member 20, a main body 30, a chassis 40, and the pill dispenser mechanism 100.

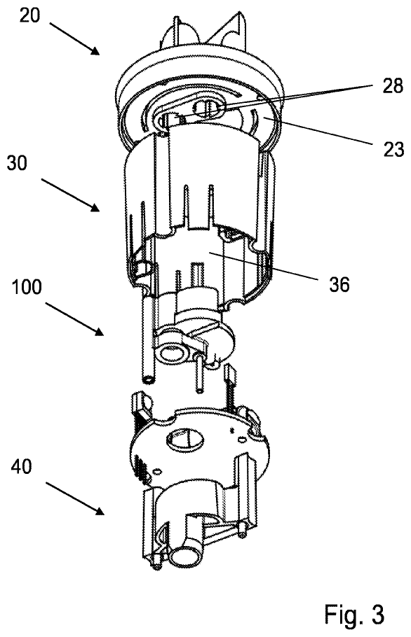

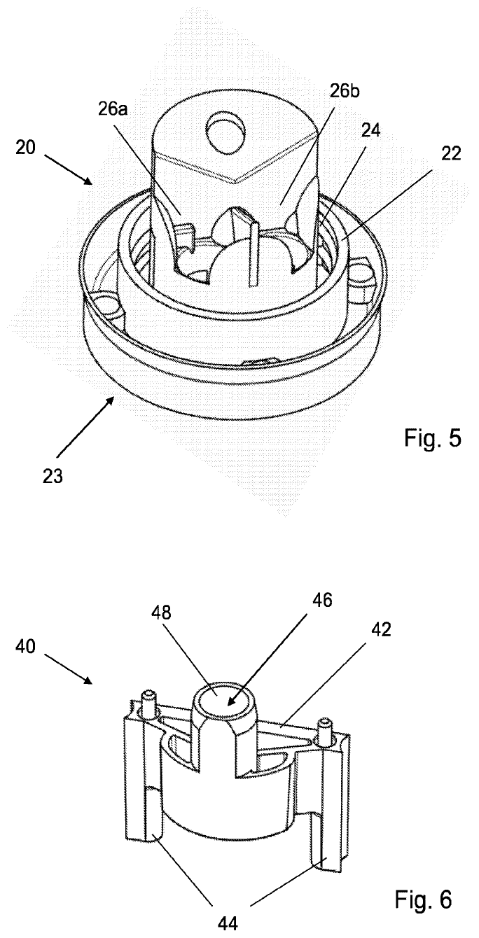

Referring to FIG. 5, the sorter member 20 comprises a ring 22 sized to fit over the neck of the container 1. The ring 22 supports a screw thread 24 at its inner surface, for engaging the screw thread in the region of the opening of the container 1. Two sorter channels 26a, 26b sort pills received from the container 1 into two columns or supply lines. Pills are supplied to the pill dispenser mechanism 100 from the sorter member 20 via outlets 28 (visible in FIG. 3) provided in the lower surface 23 of the sorter member 20, the outlets corresponding with the two sorter channels 26a, 26b. In this way, each sorter channel 26a, 26b may be referred to as a “product entry passage”, as a pill enters the pill dispenser assembly 100 via the sorter channel 26a, 26b.

Referring to FIG. 6, the chassis 40 comprises a frame 42 having a pair of legs 44 configured to engage the main body 30. A chute 46 is supported by the frame 42. The chute 46 is arranged to receive a pill from the pill dispenser mechanism 100 and guide the pill to an outlet 48 to dispense the pill to the user. In this way, the chute 46 may be referred to as a “product exit passage”, as the pill exits the pill dispenser assembly 100 to the user via the chute 46.

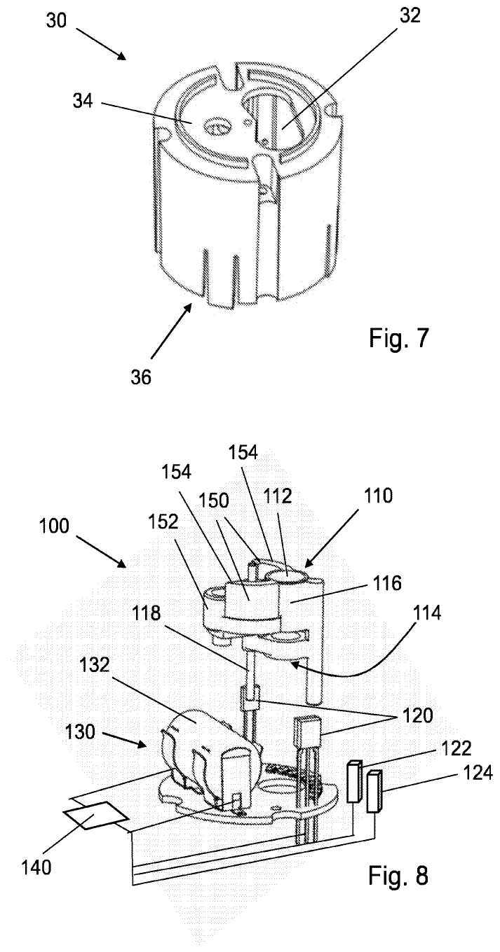

Referring to FIG. 7, the main body 30 has a hollow and generally cylindrical form. When assembled, the pill dispenser mechanism 100 is housed within the main body 30. An opening 32 is provided in the upper surface 34 of the main body 30. The lower surface 23 of the sorter member 20 is mounted at the upper surface 34 of the main body 30. The opening 32 corresponds with the two outlets 28 of the sorter member 20, such that pills from the sorter member 20 can pass through the opening 32 of the main body 30 and down to the pill dispenser mechanism 100. The main body 30 has an open lower face 36, through which the pill dispenser mechanism 100 can be inserted into the main body 30 to be mounted therein.

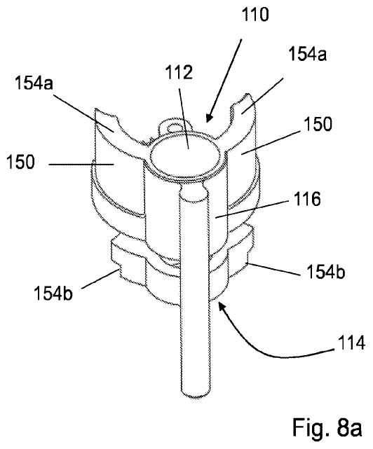

Referring to FIG. 8, the pill dispenser mechanism 100 is shown in isolation in an exploded perspective view. The pill dispenser mechanism 100 comprises a chamber 110, a product sensor 120, a drive mechanism 130, and a control unit 140. The chamber 110 is configured to receive a pill. The product sensor 120 is configured to sense the presence or absence of the pill in the chamber 110. The drive mechanism 130 is operable to cause movement of the chamber 110. The control unit 140 is configured to control the drive mechanism 130 based on the output of the product sensor 120.

The control unit 140 being configured to control the drive mechanism 130 based on the output of the product sensor 120 is advantageous in ensuring that a dispensing action is initiated, or controlled, at an appropriate time or point in a dispensing process. In some instances, it may be advantageous to cause movement of the chamber 110 only when it is established (by the product sensor 120) that a pill is present in the chamber 110. For example, this is advantageous in ensuring that operation of the drive mechanism 130 results in a pill dispensing event. In other instances, it may be advantageous not to cause movement of the chamber 110 when it is established (by the product sensor 120) that a pill is absent from the chamber 110. For example, this is advantageous in ensuring that the chamber 110 is not moved out of a position in which it can receive a pill when a pill is not present in the chamber 110. In contrast with mechanisms which may use product sensors to validate that a pill has been dispensed, the present mechanism uses the product sensor 120 as an input by which to cause a dispensing action to be initiated. That is, movement of the chamber 110 into a position where a pill may be dispensed may only be performed when it is confirmed that a pill is present in the chamber 110. Overall, a more robust mechanism and dispensing process is obtained. Patient safety is thereby improved, as improved reliability of dispensing is obtained.

The chamber 110 comprises an inlet 112 by which a pill may enter the chamber 110, and an outlet 114 by which a pill may exit the chamber 110. The chamber 110 is defined by an outer wall 116 having an inner surface and an outer surface. The chamber 110 has a cylindrical form.

The product sensor 120 is configured to sense the presence or absence of the pill in the chamber 110. In this exemplary embodiment, the product sensor 120 is a through beam sensor which detects the interruption of a beam of radiation by the presence of the pill. Alternatively, the product sensor 120 may be a micro-switch arrangement which detects the physical presence or absence of the pill in the chamber 110.

The drive mechanism 130 is operable to cause movement of the chamber 110. The drive mechanism comprises an electric motor 132, and power supply such as a battery (not shown). The drive mechanism 130 is configured to engage and rotate a shaft 118 which is rigidly connected to the chamber 110, thereby to cause rotational movement of the chamber 110.

The drive mechanism 130 being operable to cause rotational movement of the chamber 110 is advantageous in space-saving within the device. Furthermore, rotational movement of the chamber 110 facilitates movement to a position wherein the chamber 110 is out of communication with the product entry passage and also out of communication with the product exit passage. The potential for tampering with the mechanism 100 to falsely report an adherence event is reduced. This will be described in greater detail herein.

In the exemplary embodiment illustrated in the figures, the chamber 110 is retained in expected positions by virtue of a camming mechanism. That is, in a desired position of the chamber 110 (e.g., a first loading position, second dispensing position and/or third intermediate position) a component of the drive mechanism 130, or of the pill dispenser mechanism 100, may engage a cam. Alternatively, sensors may be used to detect that the chamber 110 is in the desired position, and the drive mechanism 130 controlled by the control unit 140 to cease operation when the chamber 110 is detected in the desired position. Suitable techniques for ensuring the chamber 110 is in the desired position will be well understood by the person skilled in the art.

The control unit 140 (shown schematically in FIG. 8) is configured to control the drive mechanism 130 based on the output of the product sensor 120. The control unit 140 may comprise a memory, for storing instructions therein. The memory may also contain dosage information for the patient. The control unit 140 may comprise a communication unit, for communicating with a remote server or remote device. The communication unit may transmit information to, and receive information from, the remote server or remote device.

The pill dispenser mechanism 100 further comprises an arresting arrangement 150, 152 comprising one or more arresting members 150 and a contacting member in the form of an upright 152. The arresting arrangement 150, 152 is arranged to arrest movement of the chamber 110 beyond one or more positions of displacement. Such a construction helps to ensure that the chamber 110 is moved to, and is maintained in, expected positions during a dispensing process. In this way, robustness of the dispensing process is ensured.

In this example, a pair of arresting members 150 are provided. The arresting members are in the form of arms 150 extending either side of the chamber 110. In a first position of maximum displacement, one of the arms 150 contacts an upright 152, and in a second position of maximum displacement, the other of the arms 150 contact the upright 152. In this way, the maximal range of movement of the chamber 110 is defined.

The pill dispenser mechanism 100 further comprises one or more blocking members 154. The blocking members 154 are arranged to block the product entry passage 26a, 26b when the chamber 110 is not in a first loading position (described in greater detail below). Additionally, when the chamber is in a first loading position, one of the blocking members 154 acts to block the product entry passage that the chamber 110 is not in communication with. The blocking member 154a may be referred to as “upper blocking members 154a”, relative to the dispensing orientation.

The blocking members 154 and arresting members 150 may be provided by the same component, in this case, the arms 150. Side faces of the arms 150 may provide the arresting action (by contacting the upright 152) and top faces of the arms 150 may provide the blocking action (by blocking product entry passages 26a, 26b).

Referring to FIG. 8a, blocking members 154 may also be provided adjacent to the outlet 114 by which a pill may exit the chamber 110. Said blocking members may be referred to as “lower blocking members 154b”, relative to the dispensing orientation. The lower blocking members 154b are arranged to block the product exit passage 46 when the chamber 110 is not in the second dispensing position. When the chamber 110 is not in the second dispensing position (e.g., when the chamber 110 is moved out of the second dispensing position), the lower blocking members 154b are provided so as to cover the inlet of the chute 46. The path from the product exit passage 46 to the pill dispenser mechanism 100 is thus blocked by the lower blocking members 154b. The lower blocking members 154b have a similar construction to the upper blocking members. That is, the lower blocking members 154b are in the form of arms extending from a lower region of the chamber, and lower faces of the arms may provide the blocking action.

Advantageously, the lower blocking members 154b inhibit insertion of a pill through the product exit passage 46 and into the pill dispenser mechanism 100 when the chamber 110 is not in the second dispensing position. In this way, tampering is prevented, and robustness of the pill dispenser mechanism 100 is improved as a pill cannot be inserted through the product exit passage 46 so as to jam in the pill dispenser mechanism 100 when the chamber 110 is not in the second dispensing position.

It will be appreciated that the component shown in FIG. 8a (comprising both upper blocking members 154a and lower blocking members 154b) may replace the corresponding component shown in FIG. 8 (comprising only upper blocking members 154a).

Referring back to FIG. 8, the pill dispenser mechanism 100 further comprises an orientation sensor 124. The orientation sensor 124 is configured to sense the orientation of the pill dispenser mechanism 100. The control unit 140 is configured to control the drive mechanism 130 based on the output of the orientation sensor 124. The orientation sensor 124 is configured to sense whether the pill dispenser mechanism 100, and thus the pill dispenser assembly 10, is inverted.

The orientation sensor 124 is highly advantageous in preventing and detecting patient tampering with the mechanism. As explained above, during a dispensing process the container 1 is to be disposed vertically above the pill dispenser assembly 10, and as such, during a dispensing process, the pill dispenser mechanism 100 is to be disposed in a known vertical orientation. The orientation sensor 124 detects this orientation and provides a signal to the control unit 140 to confirm this. However, where the orientation sensor 124 detects an orientation other than that intended for the dispensing process, the control unit 140 can be informed and a dispensing process, or general operation of the pill dispenser mechanism 100, can be prevented. In an example where a patient attempts to insert a pill back into the container 1, the pill dispenser mechanism 100 may be oriented in such a way to attempt to make a pill fall back (i.e., under gravity) into the container 1 through the pill dispenser mechanism 100. The orientation sensor 124 senses that the orientation is not correct for operation of the pill dispenser mechanism, and operation is prevented.

The pill dispenser mechanism 100 further comprises a position sensor 122. The position sensor 122 is configured to sense the position of the chamber 110. The control unit 140 is configured to control the drive mechanism 130 based on the output of the position sensor 122.

The position sensor 122 is highly advantageous is ensuring the correct operation of the pill dispenser mechanism 100, and thus ensuring a successful dispensing process. The position sensor 122 enables the position of the chamber 110 to be monitored, whether in a position to receive a pill from the product entry passage 26a, 26b, or to provide a pill to the product exit passage 46.

The position sensor 122 is also highly advantageous in combination with the orientation sensor 124 and product sensor 120. If a patient attempts to tamper with the device to reinsert a pill into the container, a pill may be inserted into the chamber 110 with the pill dispenser mechanism 100 oriented in the “correct” orientation for dispensing, and the pill held in the chamber 110 using an instrument. Nevertheless, the position sensor 122 will sense that the chamber 110 is in a position to dispense the pill, and the product sensor 120 will sense the presence of the pill, whereas a pill should not be present. The control unit 140 can thus register an error in the process, and take appropriate action (e.g., cease operation of the pill dispenser mechanism 100 and informing a remote server).

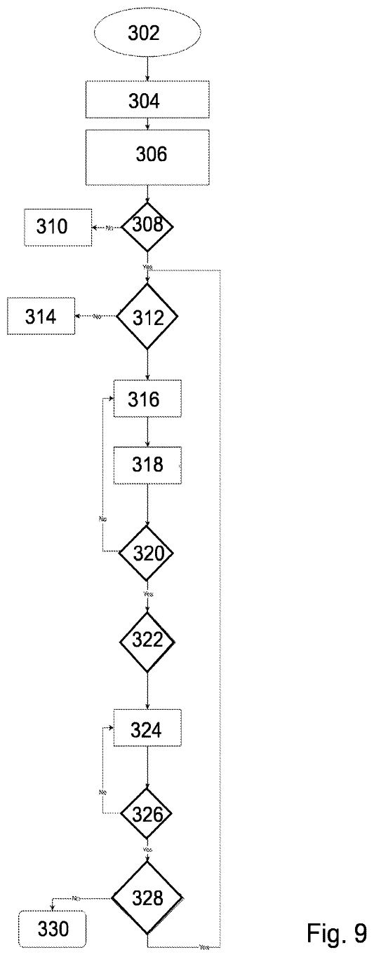

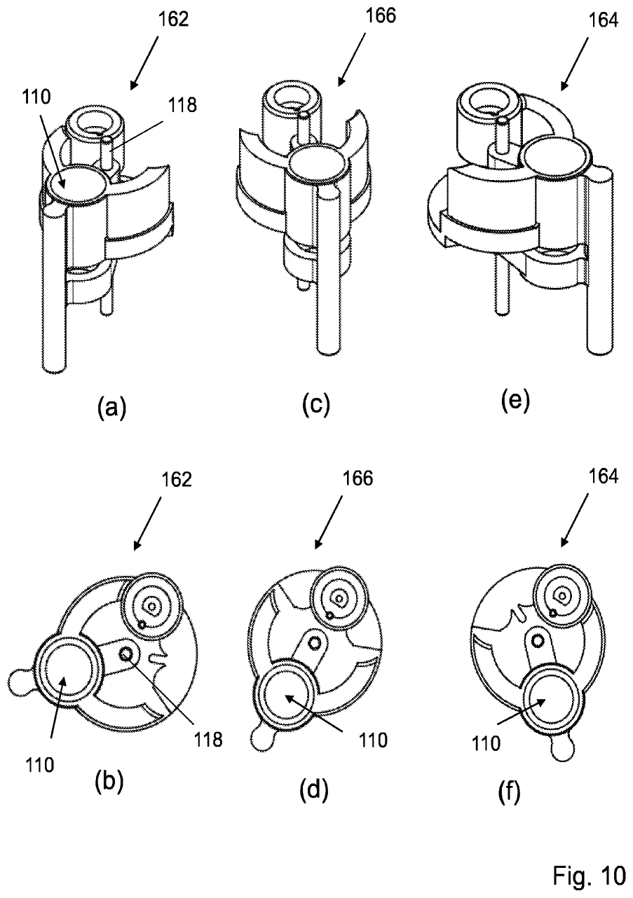

Operation of the pill dispenser mechanism 100 in the pill dispenser assembly 10 will be described in greater detail herein, with reference to FIGS. 1 to 8, the flowchart of FIG. 9, and snapshots of the chamber in various positions as shown in FIG. 10.

The pill dispenser assembly 10 comprises a pill dispenser mechanism 100. The pill dispenser assembly 10 comprises a first portion providing, or having, a product entry passage. In this example, the first portion is the sorter member 20 having a product entry passage provided by the sorter channels 26a, 26b. The pill dispenser assembly 10 comprises a second portion 16 providing, or having, a product exit passage. In this example, the second portion is the chassis having a product exit passage provided by the chute 46. The pill dispenser mechanism 100 is located between the first portion 20 and the second portion 40. The pill dispenser mechanism 100 is moveable relative to the first portion 20 and the second portion 40.

Whilst the first portion and second portion are described herein as being the sorter member 20 and chassis 40 having the above-described structural features, it will be appreciated that the first portion and second portion need not necessarily have the above-described structural features and could instead be any first portion and second portion providing a product entry passage and product entry passage. It is the function of the pill dispenser mechanism 100 to receive a pill (or “unit of product”) from the product entry passage and moves said pill to the product exit passage. Any first portion and second portion provided such passages are deemed to be suitable for use in the assembly 10 and may obtain at least some of the benefits of the invention. The specific sorter member 20 and chassis 40 employed in this exemplary embodiment may confer further, specific, advantages.

In the pill dispenser assembly 10, the control unit 140 is configured to control the drive mechanism 130 to cause movement of the chamber 110 between a first loading position and a second dispensing position. In the first loading position, the chamber 110 is in communication with the product entry passage 26a, 26b but out of communication with the product exit passage 46. In the second dispensing position, the chamber 110 is out of communication with the product entry passage 26a, 26b but in communication with the product exit passage 46.

Numerous advantages are obtained by providing the pill dispenser assembly 10 having the above-described construction and operation. In the first loading position, a pill may be passed to the pill dispenser mechanism 100 (here, by falling under gravity into the chamber 110 from the sorter member 20), but the chamber 110 (and, ultimately, the pill contained therein or the container 1) is not accessible to the user. The risk of device tampering is thereby reduced. For example, the patient therefore cannot inadvertently or deliberately access the pill in the chamber 110 whilst in the first loading position. Furthermore, in the second dispensing position, a pill may be dispensed to the user, but access to the product entry passage 26a, 26b is prevented. Similarly, the risk of device tampering is thereby reduced. For example, the patient cannot access the contents of the container, and instead receives only the intended pill dose. In other words, a form of “airlock” is thereby created, whereby it is only in the second dispensing position that the patient can access, or be provided with, the pill. The pill dispenser mechanism 100 is not accessible during loading of the pill into the pill dispenser mechanism 100.

Further features of the pill dispenser assembly 10 and operation thereof will be described in relation to the flowchart of FIG. 9 and snapshots of the chamber 110 in various positions as shown in FIG. 10. In FIGS. 10(a) and (b), the chamber 110 is shown in perspective and plan view, respectively, in a left-aligned position. When assembled in the pill dispenser assembly 10 with the sorter member 30 above and chassis 40 below, the left-aligned position is a “first loading position”, as the chamber 110 is in communication with the product entry passage 26a (i.e., the left sorter channel 26a) but is out of communication with the product exit passage 46 (i.e., the chute 46). The left-aligned first loading position is indicated generally as 162. In FIG. 10(e) and (f, the chamber 110 is shown in perspective and plan view, respectively, in a right-aligned position. When assembled in the pill dispenser assembly 10 with the sorter member 30 above and chassis 40 below, the right-aligned position is a “first loading position”, as the chamber 110 is in communication with the product entry passage 26b (i.e., the right sorter channel 26b) but is out of communication with the product exit passage 46 (i.e., the chute 46). The right-aligned first loading position is indicated generally as 164. In FIGS. 10(c) and (d), the chamber 110 is shown in perspective and plan view, respectively, in a centre-aligned position. When assembled in the pill dispenser assembly 10 with the sorter member 30 above and chassis below, the centre-aligned position is a “second dispensing position”, as the chamber 110 is in communication with the product exit passage 46 (i.e., the chute 46) but is out of communication with the product entry passages (26a, 26b). The centre-aligned second dispensing position is indicated generally as 166.

At Step 302, the pill dispenser assembly 10 is attached to the container 1. The corresponding screw threads of the container 1 and pill dispenser assembly 10 are engaged. Correct engagement is confirmed by a sensor (not shown).

At step 304, the dispensing process is initiated. In this exemplary embodiment, the patient may be informed (e.g., by audible notification, smart phone notification, or the like) that the patient is due a dose. That the patient is due a dose may be communicated to the communication unit of the control unit 140 from a remote server or remote device. The patient presses a dispense button (not shown) to initiate the dispensing process.

At step 306, the patient inverts the container 1 and the attached/engaged pill dispenser assembly 10 (relative to the orientation shown in FIG. 1). The pill dispenser assembly 10 is thereby vertically disposed above the container 1, such a pill may fall under gravity into the pill dispenser mechanism 100. The control unit 140 confirms that the chamber is in the first loading position 162, 164 by reference to the output of the position sensor 122. This may require the control unit 140 to control the drive mechanism 130 to cause movement of the chamber 110 to the first loading position 162, 164. In the first loading position, a pill will fall under gravity from the sorter channel 26a, 26b which the chamber 110 is in communication with into the chamber 110. In the first loading position 162, 164, one of the blocking members 154 blocks the sorter channel outlet 28 that the chamber 110 is not in communication with in the first loading position 162, 164. That is, the sorter member 20 comprises a plurality of product entry passages 26a, 26b and the blocking members 154 are arranged to block at least one of the plurality of product entry passages 26a, 26b that the chamber is not in communication with in the first loading position 162, 164. Advantageously, in this way, a construction is facilitated whereby a plurality of sorter channels 26a, 26b may be provided (which has benefits in organising the pills in the sorter member 20), but the blocking members 154 prevent pills from becoming lodged in the mechanism 100 during loading.

At step 308, the control unit 140 confirms that the orientation of the pill dispenser assembly 10 is correct, by reference to the output of the orientation sensor 124. If the orientation is incorrect (for example, the pill dispenser assembly 10 is not inverted), the dispensing process is terminated at Step 310, and the patient is informed. If the orientation is correct, the dispensing process proceeds to Step 312.

At Step 312, the control unit 140 establishes whether a pill is present in the chamber 110, by reference to output of the product sensor 120. If no pill is present in the chamber 110, the dispensing process is terminated at Step 314, and the patient is informed. If a pill is present in the chamber 110, the dispensing process proceeds to step 316.

At Step 316, the control unit 140 controls the drive mechanism 130 to cause movement of the chamber from the first loading position 162, 164 to the second dispensing position 166. In this way, the chamber 110 is moved out of communication with the product entry passage 26a, 26b and into communication with the product exit passage 46. The drive mechanism 130 rotates shaft 118 to cause the chamber 110 to move from the first loading position 162, 164 to the second dispensing position 166.

In view of the above checks involving sensor outputs, it is apparent that the control unit 140 is configured to control the drive mechanism 130 to cause movement of the chamber 110 away from the first loading position 162, 164 based on: the output of the orientation sensor 124 indicating that the mechanism is in a first orientation (e.g., inverted); the output of the product sensor 120 indicating the presence of a pill in the chamber 110; and the output of the position sensor 122 indicating that the chamber is in the first locating position 162, 164. Such control is advantageous, as robustness of the dispensing process, and ultimately patient safety, is ensured. Increased certainty of a dispensing event having taken place is provided.

The control unit 140 is configured to control the drive mechanism 130 to cause movement of the chamber between the first loading position 162, 164, the second dispensing position 166, and a third intermediate position wherein the chamber is out of communication with both the product entry passage 26a, 26b and the product exit passage 46. During Step 312, the control unit 140 controls the drive mechanism 130 to cause movement of the chamber 110 from the first loading position 162, 164 to the second dispensing position via a third intermediate position. In this way, the chamber 110 is simultaneously inaccessible to the patient and out of communication with the container 1. Errors in the dispensing process are avoided, and a dispensing event may be accurately recorded and monitored.

At Step 318, as the chamber 110 moves out of communication with the product entry passage 26a, 26b, the container 1 is inaccessible from the chamber 110. The blocking members 154 are brought beneath the outlets 28 of the sorter channels 26a, 26b, thereby to prevent pills from the sorter channels falling down into the pill dispenser mechanism 100. In this way, the blocking members 154 block the product entry passage 26a, 26b when the chamber is not in the first loading position 162, 164. Advantageously, the blocking members 154 prevent pills becoming lodged in, or jamming, the mechanism 100 during loading.

At Step 320, the control unit 140 establishes whether the chamber 110 is in the second dispensing position 166, by reference to the output of the position sensor 122. In other words, the position sensor 122 is used to establish whether the chamber 110 is in communication with the chute 46 such that the pill can be passed to the chute 46 for dispensing to the patient. If the position sensor 122 indicates that the chamber 110 is not in the second dispensing position 166, then the dispensing process returns to Step 316, to continue to cause movement of the chamber 110 to the second dispensing position 166. If the position sensor 122 indicates that the chamber 110 is in the second dispensing position 166, the dispensing process proceeds to Step 322.

At Step 322, the control unit 140 confirms that the pill has left the chamber 110, by reference to the output of the product sensor 120. The pill exits the chamber 110 of the pill dispenser mechanism 100 and is passed (e.g., falls) to the chute 46, through the chute 46, and is dispensed to the patient. A dispensing event can thereby be recorded. The dispensing event is recorded with high certainty due to the sensor checks performed during the dispensing process.

At Step 324, following dispensing of the pill to the patient, the control unit 140 controls the drive mechanism 130 to cause movement of the chamber 110 away from the second dispensing position 166. The chamber 110 is moved to the first loading position 162, 164. Again, movement is via the third intermediate position. In this exemplary embodiment, the chamber 110 is moved to a first loading position 162, 164 which was not the first loading position 162, 164 used during the previous pill dispense. That is, the chamber 110 is moved into communication with the other one of the sorter channels 26a, 26b. In this way, the dispensing process makes improved use of the range of rotational movement of the chamber 110.

In view of the above checks involving sensor outputs, it is apparent that the control unit 140 is configured to control the drive mechanism 130 to cause movement of the chamber 110 away from the second dispensing position 166 based on: the output of the orientation sensor 124 indicating that the mechanism is in a first orientation (e.g., inverted); the output of the product sensor 120 indicating the absence of a pill in the chamber 110; and the output of the position sensor 122 indicating that the chamber is in the second dispensing position 162, 164. Such control is advantageous for numerous reasons. A particular advantage is that a check is performed to ensure the chamber 110 does not contain a pill. Thus, if a patient attempts to return, or otherwise insert a pill back into the container 1, by introducing the pill into the chamber 110, the presence of the pill in the chamber 110 will be sensed and the drive mechanism 130 will not move away from the second dispensing position 166. As a result, it is not possible for the patient to reinsert a pill into the container 1. Where this occurs, a remote server or remote device can be informed of the attempt to reinsert and pill into the container 1, such that monitoring of adherence is improved. Similarly, where the patient holds the assembly in a non-inverted orientation, to attempt to force a pill to fall under gravity back into the container 1, this will be sensed by the orientation sensor 124 and the chamber 110 will not be moved away from the second dispensing position 166.

At Step 326, the control unit 140 establishes whether the chamber 110 is in the first loading position 162, 164, by reference to the output of the position sensor 122. If the chamber is not in the first loading position 162, 164, the dispensing process returns to Step 324. If the chamber 110 is in the first loading position 162, 164 the dispensing process proceeds to Step 328.

At Step 328, the control unit 140 establishes whether additional pills are to be dispensed to the patient. This may be established by referring to the control unit memory, or to data transmitted to the communication unit from a remote server or remote device. If no additional pills are to be dispensed to the patient, the dispensing process proceeds to Step 330. If an additional pill is to be dispensed to the patient, the dispensing process returns to Step 312 to introduce the next pill into the chamber 110. A further advantage of this exemplary embodiment is that one (i.e., a single pill) is dispensed to the patient at a time. In this way, the assembly 10 and mechanism 100 can be used to dispense high-risk drugs, for example drugs that may be toxic in high doses. Furthermore, dispensing to vulnerable patients is made safer, as the dose is controlled by the device, and can be monitored remotely.

Once all pills in the dose are dispensed to the patient, the dispensing process proceeds to Step 330. At Step 330, the dispensing process is terminated and the chamber 110 is maintained in the first loading position 122, 124.

Applicable to the above description of the dispensing process, each step may be monitored by the control unit 140. The correct progression through the process can be reported to a remote server or remote device by the control unit 140. In this way, any errors or irregularities in the dispensing process can be determined, and appropriate action taken, for example terminating the dispensing process and/or reporting the errors or irregularities to a monitoring party such as a GP or clinical trial.

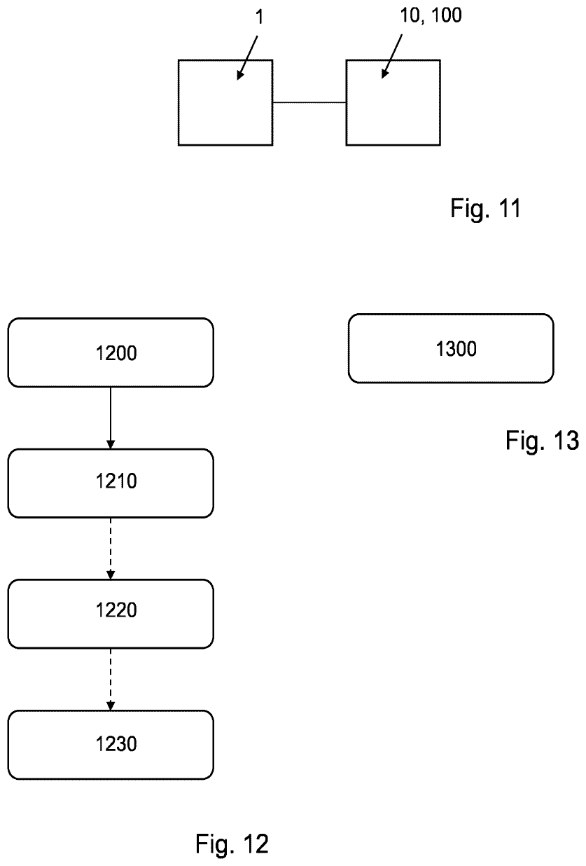

Referring to FIG. 11, a kit of parts is schematically shown. The kit comprises a pill dispenser mechanism 100, or a pill dispenser assembly 10, and a container 1 for containing one or more pills.

Referring to FIG. 12, a method of operation of a pill dispenser mechanism 100 is schematically shown. Step 1200 comprises sensing the presence or absence of a pill in a chamber. Step 1210 comprises controlling a drive mechanism operable to cause movement of the chamber based on the sensing the presence or absence of the pill in the chamber. Optional Step 1220 comprises sensing the orientation of the pill dispenser mechanism, Optional Step 1230 comprises controlling the drive mechanism based on the sensing the orientation of the pill dispenser mechanism.

Referring to FIG. 13, a method of operation of a pill dispenser assembly 10 is shown. Step 1300 comprises controlling a drive mechanism to cause movement of a chamber between: a first loading position wherein the chamber is in communication with a product entry passage but out of communication with a product exit passage; and a second dispensing position wherein the chamber is out of communication with the product entry passage but in communication with the product exit passage.

It will be appreciated that the method of operation of the pill dispenser mechanism 100 and/or method of operation of the pill dispenser assembly 10 may incorporate any or all of the features of, or operations of, the pill dispenser mechanism 100 or pill dispenser assembly 10, as desired or as appropriate. In particular, the methods may comprise any operation described in relation to the flowchart of FIG. 9.

### Definitions

Although a preferred embodiment has been shown and described, it will be appreciated by those skilled in the art that various changes and modifications might be made without departing from the scope of the invention, as defined in the appended claims and as described above.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A pill dispenser mechanism for a pill dispenser assembly,
the pill dispenser mechanism comprising:
a chamber configured to receive a pill;
a product sensor configured to sense presence or absence of the pill in the chamber;
a drive mechanism operable to cause movement of the chamber; and
a control unit configured to control the drive mechanism based on output of the product sensor.

2. A pill dispenser mechanism according to claim 1, wherein the drive mechanism is operable to cause rotational movement of the chamber.

3. A pill dispenser mechanism according to claim 1, further comprising an arresting arrangement arranged to arrest movement of the chamber beyond one or more positions of displacement.

4. A pill dispenser mechanism according to claim 1, further comprising an orientation sensor configured to sense the orientation of the pill dispenser mechanism, wherein the control unit is configured to control the drive mechanism based on the output of the orientation sensor.

5. A pill dispenser mechanism according to claim 1, further comprising a position sensor configured to sense the position of the chamber, wherein the control unit is configured to control the drive mechanism based on the output of the position sensor.

6. A pill dispenser assembly comprising:
a pill dispenser mechanism according to claim 1;
a first portion having a product entry passage; and
a second portion having a product exit passage,
wherein the pill dispenser mechanism is located between the first portion and second portion, the pill dispenser mechanism being moveable relative to the first portion and second portion,
wherein the control unit is configured to control the drive mechanism to cause movement of the chamber between:
a first loading position wherein the chamber is in communication with the product entry passage but out of communication with the product exit passage; and
a second dispensing position wherein the chamber is out of communication with the product entry passage but in communication with the product exit passage.

7. A pill dispenser assembly according to claim 6, wherein the control unit is configured to control the drive mechanism to cause movement of the chamber between the first loading position, the second dispensing position, and a third intermediate position wherein the chamber is out of communication with both the product entry passage and the product exit passage.

8. A pill dispenser assembly according to claim 6, wherein the control unit is configured to control the drive mechanism to cause movement of the chamber away from the first loading position based on one or more of:
the output of an orientation sensor indicating that the mechanism is in a first orientation;
the output of the product sensor indicating the presence of a pill in the chamber; and
the output of the position sensor indicating that the chamber is in the first locating position.

9. A pill dispenser assembly according to claim 8, wherein the control unit is configured to control the drive mechanism to cause movement of the chamber from the first loading position to the second dispensing position.

10. A pill dispenser assembly according to claim 9, wherein the control unit is configured to control the drive mechanism to cause movement of the chamber from the first loading position to second dispensing position via a third intermediate position wherein the chamber is out of communication with both the product entry passage and the product exit passage.

11. A pill dispenser assembly according to claim 6, wherein the control unit is configured to control the drive mechanism to cause movement of the chamber away from the second dispensing position based on one or more of:
the output of an orientation sensor indicating that the mechanism is in a first orientation;
the output of the product sensor indicating the absence of a pill in the chamber; and
the output of the position sensor indicating that the chamber is in the second dispensing position.

12. A pill dispenser assembly according to claim 11, wherein the control unit is configured to control the drive mechanism to cause movement of the chamber from the second dispensing position to the first loading position.

13. A pill dispenser assembly according to claim 12, wherein the control unit is configured to control the drive mechanism to cause movement of the chamber from the second dispensing position to the first loading position via a third intermediate position wherein the chamber is out of communication with both the product entry passage and the product exit passage.

14. A pill dispenser assembly according to claim 6, wherein the pill dispenser mechanism comprises one or more blocking members arranged to block the product entry passage when the chamber is not in the first loading position.

15. A pill dispenser assembly according to claim 14, wherein the first portion comprises a plurality of product entry passages and the blocking members are arranged to block at least one of the plurality of product entry passages that the chamber is not in communication with in the first loading position.

16. A pill dispenser assembly according to claim 14, wherein the blocking members and an arresting arrangement are at least in part defined by a pair of arms extending from or adjacent to the chamber; wherein the arresting arrangement is arranged to arrest movement of the chamber beyond one or more positions of displacement.

17. A pill dispenser mechanism according to claim 1, wherein the pill dispenser mechanism is retro-fitted to an opening of an existing container.

18. A kit of parts comprising: a pill dispenser mechanism according to claim 1, and a container for containing one or more pills.

19. A method of operation of a pill dispenser mechanism comprising:
sensing presence or absence of a pill in a chamber; and
controlling a drive mechanism operable to cause movement of the chamber based on the sensing the presence or absence of the pill in the chamber.

20. A method according to claim 19, the method comprising:
sensing orientation of the pill dispenser mechanism; and
controlling the drive mechanism based on the sensing the orientation of the pill dispenser mechanism.

21. A method of operation of a pill dispenser assembly comprising:
controlling a drive mechanism to cause movement of a chamber between:
a first loading position wherein the chamber is in communication with a product entry passage but out of communication with a product exit passage; and
a second dispensing position wherein the chamber is out of communication with the product entry passage but in communication with the product exit passage.
